(19) United States
(12) Patent Application Publication
(10) Pub. No.: US 2010/0131846 A1
(43) Pub. Date: May 27, 2010

(54) METHODS, RENDERING APPLICATION, PORTABLE APPARATUS, AND COMPUTER PROGRAM FOR CREATING A PLAYLIST

(75) Inventor: Christian Ostergaard, Vaerlose (DK)

Correspondence Address: Perman & Green, LLP, 99 Hawley Lane, Stratford, CT, 06614, US

(73) Assignee: NOKIA CORPORATION, Espoo (FI)

(21) Appl. No.: 12/596,689

(22) PCT Filed: Jun. 25, 2007
(86) PCT No.: PCT/IB07/01886

§ 371 Date: Jan. 22, 2010

Related U.S. Application Data
(60) Provisional application No. 60/914,116, filed on Apr. 26, 2007.

(51) Int. Cl. G06F 3/048

(52) U.S. Cl. 715/716; 715/810

(57) ABSTRACT

A mobile communication apparatus includes a display and means for navigating among items displayed on the display, arranged to enable selection of a first item, in the display view, from a multitude of lists of items. Upon selection of the first item, the selected first item is associated with a playlist including at least the selected item, wherein the item or items in the playlist are arranged in sequential order. A corresponding application, apparatus, user interface, and computer program is also disclosed.

### CROSS REFERENCE TO RELATED APPLICATIONS

This application is the National Stage of International Application No. PCT/IB2007/001886 International Filing Date, 25 Jun. 2007, which designated the United States of America, and which International Application was published under PCT Article 21 (2) as WO Publication No. WO2008/132538 A1 and which claims priority from and the benefit of U.S. Provisional Application No. 60/914,116 filed on 26 Apr. 2007, the disclosures of which are incorporated herein by reference in their entireties.

### BACKGROUND

1. Field

The disclosed embodiments relate to methods for creating a playlist out of selectable multimedia items in a portable apparatus, a rendering application, a portable apparatus comprising a display and means for navigating, and a computer-readable medium having computer-executable components.

2. Brief Description of Related Developments

Nowadays large quantities of multimedia items are stored in devices with processing and storage capabilities, such as computers, media players, and mobile communication apparatuses. These stored multimedia items are often scattered throughout different folders in the device, which can cause problems for instance when a user wants to create a multimedia item playlist. For example, multimedia items such as a music files can typically be found both in the ‘Music’ folder, belonging to the music rendering application, in the ‘Downloads’ folder, together with other downloaded multimedia items, in the ‘Incoming mail’ folder, together with other received multimedia items, or in some user selected folder. If a user wants to make a music playlist for rendering in the music rendering application, the user first have to move all music files to a preset folder, such as the ‘Music’ folder belonging to the music rendering application, before a playlist can be created. To locate and to move all music files to one folder is very tedious. This is especially cumbersome in nowadays apparatuses with large storage capabilities and with several different ways of inputting and receiving multimedia files. However, it is believed that improvements can be made to facilitate for a user to easily create playlists, of multimedia items of the same type, without moving and collecting them in a specific folder.

### SUMMARY

In view of the above, an objective of the disclosed embodiments is to solve or at least reduce the problems discussed above. In particular, an objective is to provide a user friendly and efficient way of creating and rendering playlists of multimedia items of the same type in a portable apparatus.

According to a first aspect of the disclosed embodiments, there is provided a method for a portable apparatus, comprising:

enabling selection of a first item in a display view from a multitude of lists of items;
upon selection of first item, associate selected first item with a playlist comprising at least the selected item, wherein said item or items in said playlist are arranged in sequential order.

The method may comprise enabling selection of a further item or items from said multitude of lists.

The method may comprise associating said further selected item or items with said playlist.

The method may comprise re-arranging selected associated items in said playlist in a second sequential order.

The method may comprise rendering an associated item in said playlist.

The method wherein any of said multitude of lists and said playlist is a list comprising multimedia items.

The method wherein said items are any items of the group comprising:

an audio item, a video item, and a picture item.

According to a second aspect of the disclosed embodiments, there is provided a rendering application for an portable apparatus comprising a display and navigation means, said application causing a list of items to be displayed in a display view and being capable of enabling selection of a first item in said list by said means for navigation, wherein, upon selection of said first item, associate said first item with a playlist, and enabling selection of further item or items from a multitude of lists by said means for navigation, wherein, upon selection of said further item or items, be associated to said playlist, wherein said item or items in said playlist are arranged in a sequential order.

According to a third aspect of the disclosed embodiments, there is provided an apparatus comprising a display and means for navigating among items displayed on said display, arranged to display a view comprising a first list of items on said display and being capable of enabling selection of a first item among said items by said means for navigation, wherein upon selection of said first item, being arranged to associate the said selected item with a playlist, and further being capable of enabling selection of a further item or items from a multitude of lists by said means for navigation, wherein upon selection of said further items, being arranged to associate the said selected items with said playlist, wherein said item or items in said playlist are arranged in a sequential order.

According to a fourth aspect of the disclosed embodiments, there is provided a computer-readable medium having computer-executable components comprising instructions for enabling selection of a first item in a display view from a multitude of lists of items;

upon selection of first item, associate selected first item with a playlist comprising at least the selected item, wherein said item or items in said playlist are arranged in sequential order.

According to a fifth aspect of the disclosed embodiments, there is provided a user interface comprising

a display, and an input receiver, wherein the user interface is arranged to enable a portable apparatus for selection of items in a display view, and to display lists of said items in said display view.

The second, third, fourth, and fifth aspects of the disclosed embodiments may be combined in any way with the features of the first aspect of the present embodiments.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the disclosed embodiments will appear from the following detailed disclosure, from the attached dependent claims as well as from the drawings.

The above, as well as additional objects, features and advantages of the disclosed embodiments, will be better understood through the following illustrative and non-limiting detailed description of the preferred embodiments, with reference to the appended drawings, where the same reference numerals will be used for similar elements, wherein:

### BRIEF DESCRIPTION OF THE DRAWINGS

FIG. 1 shows a mobile communication apparatus according to an aspect of the disclosed embodiments;

FIG. 2 is a flow chart for a process according to an aspect of the disclosed embodiments;

FIG. 3 shows a display view according to an aspect of the disclosed embodiments;

FIG. 4 shows a display view according to an aspect of the disclosed embodiments;

FIG. 5 shows a display view according to an aspect of the disclosed embodiments;

FIG. 6 shows a display view according to an aspect of the disclosed embodiments;

FIG. 7 shows a display view according to an aspect of the disclosed embodiments;

FIG. 8 shows a display view according to an aspect of the disclosed embodiments;

FIG. 9 illustrates a computer readable medium according to an aspect of the disclosed embodiments; and

FIG. 10 illustrates a user interface of the disclosed embodiments.

### DETAILED DESCRIPTION OF THE DISCLOSED EMBODIMENTS

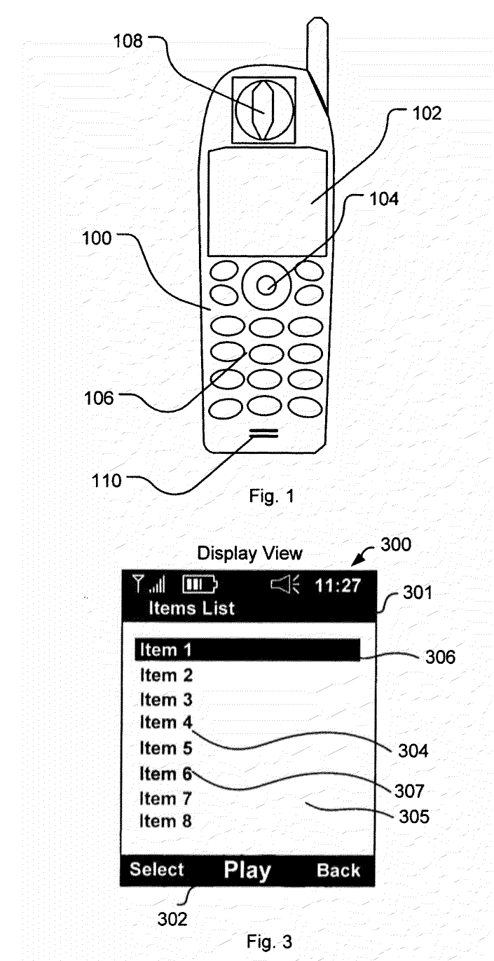

FIG. 1 shows a mobile communication apparatus 100 comprising a display 102 and means 104 for navigating among items (not shown) displayed in a display area 102. The navigation means 104 can be a rotating input, a joystick, a touch pad, but can also be implemented using a touch sensitive display, wherein the displayed items directly can be tapped by a user for selection, or be voice activated via a headset or a built-in microphone.

The mobile communication apparatus can also comprise other elements normally present in such an apparatus, such as a keypad 106, a speaker 108, a microphone 110, a processor (not shown), a memory (not shown), etc.

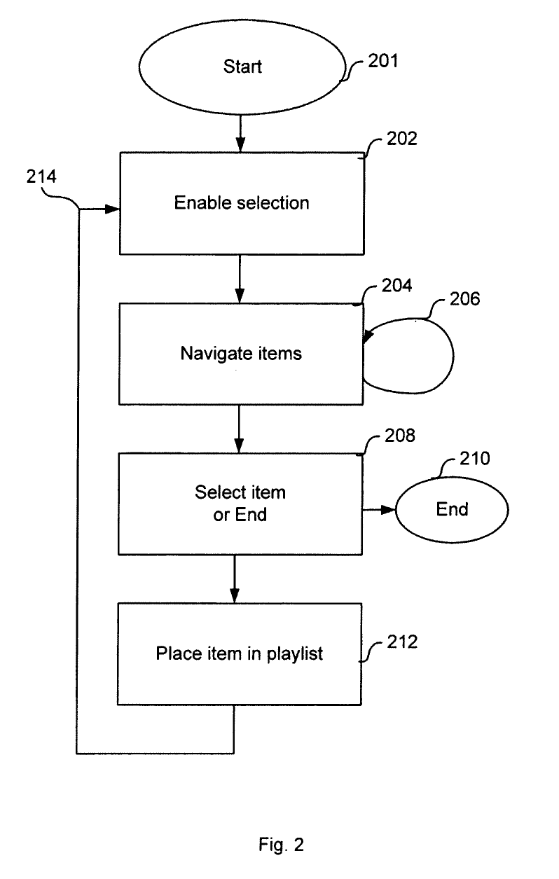

FIG. 2 shows a flowchart illustrating one aspect of the disclosed embodiments. A common process of selecting and placing an item in a playlist starts 201 by enabling 202 the apparatuses for selection amongst a plurality of items in the apparatuses receding in one or more folders and subfolders. Navigation amongst the items, in one or more folders 204, can be done by using the navigation means 104 in FIG. 1. The navigation proceeds 206 until either the selection process is ended 210, by for example selecting ‘quit’ or ‘end’ 208, or an item is selected 208. If no current playlist exists the selected item 208 is placed 212 in a new play list, and if a current playlist exits the item is placed 212, by default, last in the current playlist. Items can in another embodiment be placed either first, last, in the middle, or any other position in the list. The playlist can also be modified, meaning rearranging the order amongst items and/or discarding items in the playlist, before or after an item has been placed or after completion of the playlist, in another embodiment. When an item has been placed in a playlist the apparatus is enabled 214 so that the selection 202 and navigation 204, 206 can continue until the user wishes to end the process.

FIG. 3 illustrates an example of a common display view in a mobile communication apparatus 300 comprising a general status indication section 301, a softkey bar 302 and a general display area 305. The general status indication section 301 can for example include symbols for battery status, reception quality, speaker on/off, present mode, clock time, etc. The status indication section is not in any way limited to only include these symbols. Thus, other symbols in any shape, form or color can occur. The softkey bar 302, situated at the bottom of the display view, is operable using the navigation means 104 mentioned in conjunction with FIG. 1. The functions of these softkeys are not limited by the functions indicated in the figure.

The preferred function of the general display area 305, residing between the status indication section 301 at the top and the softkey bar 302 at the bottom, is to display information from running applications in the mobile communication apparatus. In our case the display area 305 displays lists of items 304 which are maneuverable with the aid of the navigation means 104 in FIG. 1. The current selectable item in the display area 305 is in our case indicated using a black bar 306. However, other forms of indications and ways of highlighting selectable items exist. A selected item, such as ‘Item 6’ 307, is in our case indicated by highlighting.

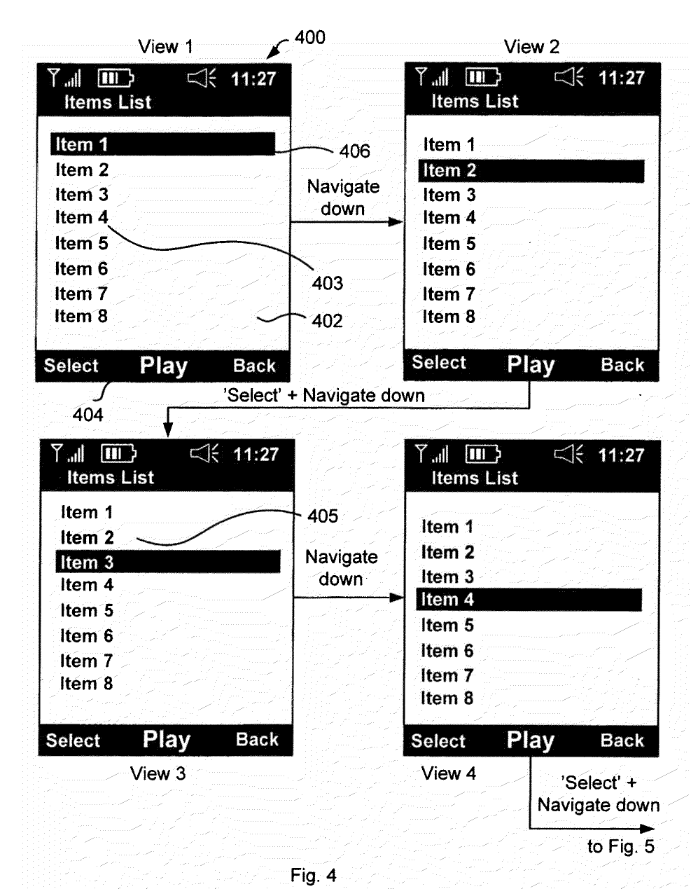

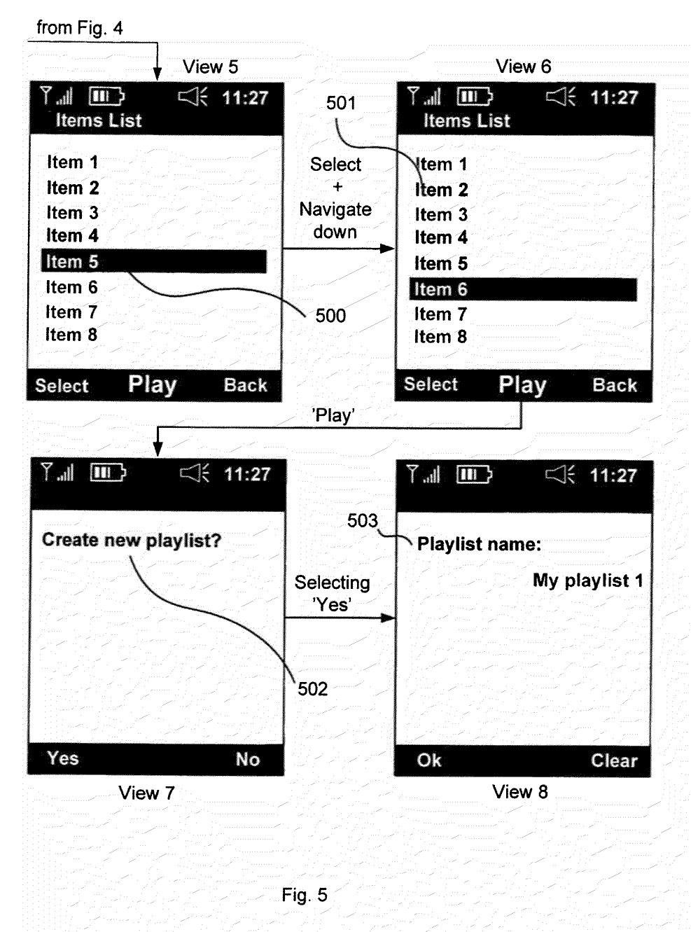

FIG. 4 shows an aspect of the disclosed embodiments. The common display view 400 is the same as in the example in FIG. 3, and the multimedia items displayed in the list 403 in the display area 402 are to be considered to be of the same type (e.g. audio items, video items, picture items, etc.).

The user of the mobile communication apparatus can navigate throughout the list, or select an item, using either the navigation means 104 discussed in conjunction with FIG. 1 or the softkey bar 404. A black cursor 406 indicates which item that can be operated on in a particular instance.

In the illustrated example a user wants to create a playlist containing items ‘Item 2’, ‘Item 4’ and ‘Item 5’ from the item list 403 shown in the display area. The user navigates down to ‘Item 2’, shown in view 2, and selects the item by operating ‘Select’. As shown in view 3, in FIG. 4, the selected item ‘Item 2’ is highlighted 405 in comparison to the other non-selected items. The user then navigates down and selects ‘Item 4’ as shown in view 3 and 4, in FIG. 4. The continuation of the navigation and selection procedure is found in FIG. 5, view 5.

In view 5 the user have navigated down to ‘Item 5’ 500. The user then selects ‘Item 5’ and navigates down to ‘item 6’, shown in view 6. As shown in view 6 in FIG. 5 the user have now selected ‘Item 2’, ‘Item 4’ and ‘Item 5’ as indicated by the highlighting 501 and continues to create a playlist containing the selected items. The user proceeds by selecting ‘Play’ which, if multiple items have previously been selected, prompts the user, as shown in view 7, to choose if a playlist is going to be created or not 502. If only one item had been selected the selected item had been rendered by an appropriated rendering application (e.g. music application for music files, video application for movie files, or other type of item) If ‘No’ is selected, no playlist is created and the first/last (user configurable) selected item is rendered by an appropriated rendering application. If ‘Yes’ is selected a new display view, shown in view 8, enables the user to enter an appropriate name 503 for the playlist. When a playlist has been created the items in the playlist is rendered in the order they have been selected (or re-arranged in), i.e. in our case ‘Item 2’ is rendered first then ‘Item 4’ and so on. When the playlist creation process is completed (or abandoned) the display view returns to the item list, as displayed in view 1 in FIG. 4, enabling the user to either select items for a new playlist or to add more items or to edit (re-arrange, delete, etc.) an existing playlist.

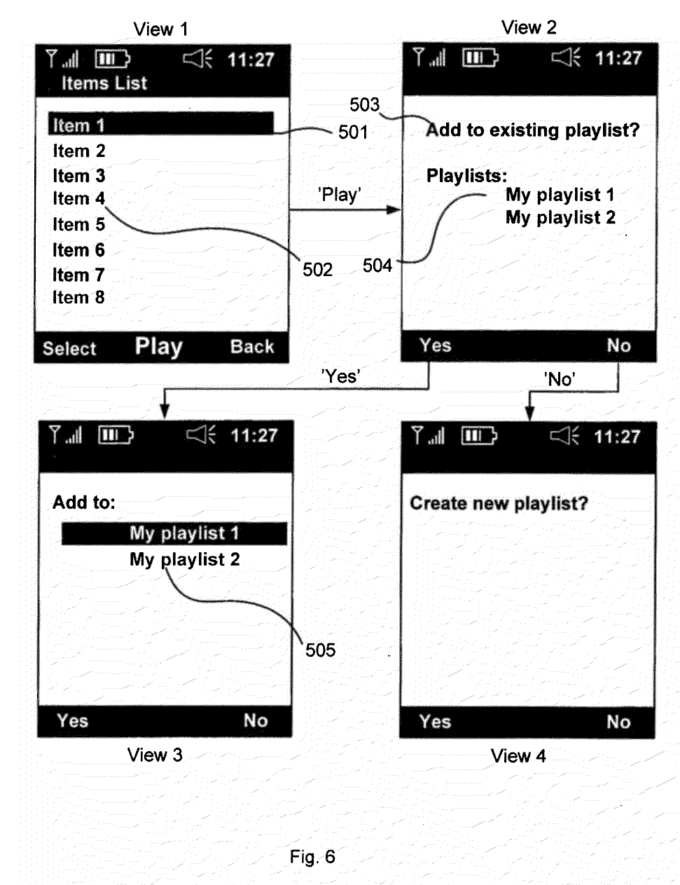

FIG. 6 shows an example of how selected items can be added to an existing playlist. View 1 in FIG. 6 illustrates that the user has selected items ‘Item 3’, ‘Item 6’ and ‘Item 7’ (highlighted) from the list of items 502. The user then selects ‘Play’. Since there already exists two playlists, ‘My playlist 1’ and ‘My playlist 2’ 504, a display view asking the user if the user wants to add the selected items to an existing playlist 503 is shown. If the user selects ‘Yes’ then the user gets prompted to select which existing playlist to add the selected items to 505. If no previous playlist exists or the user selects ‘No’ in display view 2, the user gets prompted to create a new playlist as shown before in FIG. 5 view 7.

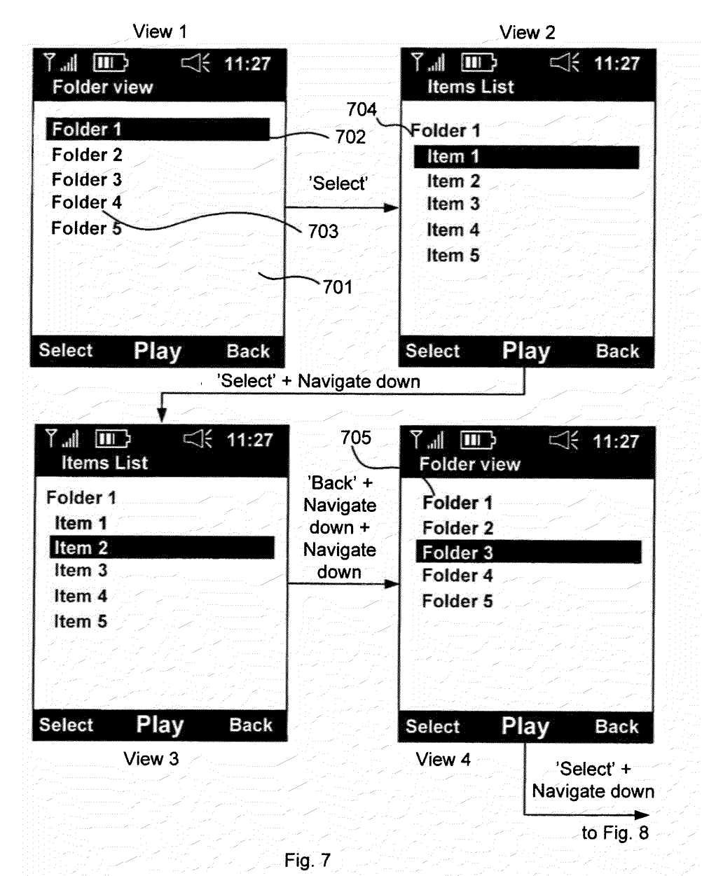

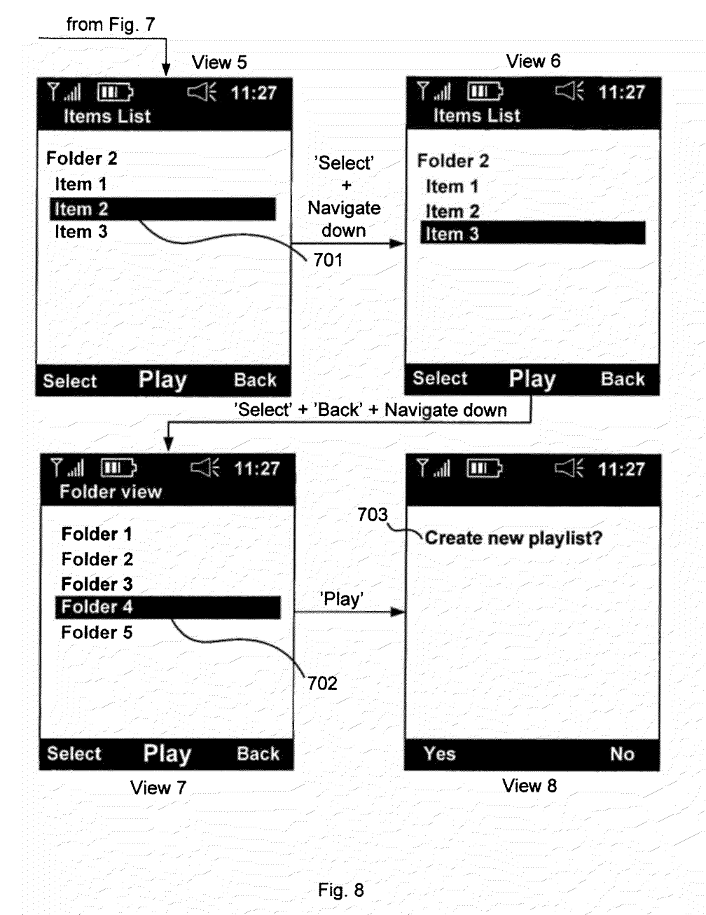

FIG. 7 shows another aspect of the disclosed embodiment. A user wants to create a playlist out of the same type of items (e.g. audio items) scattered between different folders that may contain other types of items (e.g. video items, picture items, or other). The display area 701 in display view 1 in FIG. 7 shows a list of folders 703 holding multimedia items. The user has placed the cursor on ‘Folder 1’ 702 and operate ‘Select’ to open the folder as shown in view 2. The folder content containing a list of items 704 is displayed in a new display view as shown in view 2. The user selects ‘Item 1’ and navigates down as shown in view 3. The user navigates back to the folder view (view 4) by selecting ‘Back’ and navigates down two times to ‘Folder 3’ as shown in view 4. Folder 1 in display view 4 is highlighted to show that one or more items in that folder have been selected 705.

The example of the selection process is continued in FIG. 7 view 5. The user has selected ‘Folder 2’ and navigated down to ‘Item 2’ 701 as shown in view 5. The user selects ‘Item 2’ and navigates down to ‘Item 3’ as shown in display view 6. The user then selects ‘Item 3’, navigates back to the folder view by operating ‘Back’, and navigating down to ‘Folder 4’ 702 as shown in display view 7. The user have now selected multiple items, of the same type, in multiple folders and selects ‘Play’ to create a playlist. The user gets prompted to confirm that a new playlist is going to be created 703, or not, as shown in display view 8. If there already exists playlists the user first gets prompted, as shown in FIG. 6, to include the selected items in an existing play list, or not. When a playlist has been created the items in the playlist is rendered in the order they have been selected (or re-arranged in), i.e. in our case ‘Item 1’ in ‘Folder 1’ is rendered first then ‘Item 2’ in ‘Folder 3’ and so on. When the playlist creation process is completed (or abandoned) the display view returns to the item list, as displayed in view 1 in FIG. 4, enabling the user to either select items for a new playlist or to add more items or to edit (re-arrange, delete, etc.) an existing playlist.

As described in above disclosure the user can easily navigate between folders containing different types of items and freely select items, of the same type, to create playlists without first grouping items of the same type in a specific folder. This way of creating playlists saves the user both time and effort and offers full flexibility.

Throughout this disclosure, references have been made to multimedia items. It will readily be understood by a person skilled in the art that a multimedia file can be any of the type audio file, video file, image file, or any other similar file capable of being rendered by a multimedia application. It will also be understood that rendering different types of items will in some cases requiring different kind of applications suitable for that particular type and that it will produce different kinds of effect. For example, by rendering a playlist containing audio items a media player will play the audio files in sequence determined by the playlist, by rendering a playlist containing video items a media player will play the video items in sequence determined by the playlist, by rendering a playlist containing picture items a media player will create a slideshow and show the pictures in sequence determined by the playlist, etc.

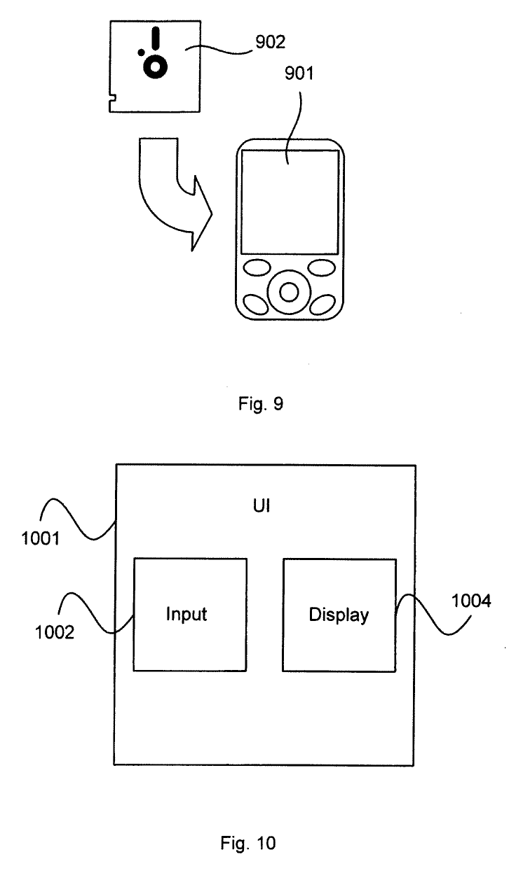

The disclosed embodiments can be computer-implemented, i.e. the media handling is performed on a general or dedicated computerized apparatus 901, such as a personal computer, a mobile phone, a digital camera, a personal digital assistant, a media player, or other similar apparatus. Instructions for performing the disclosed embodiments can then be executed by the apparatus. These instructions can be loaded into the apparatus 901 from a computer-readable medium 902, as exemplary illustrated in FIG. 9, having a data structure stored. The data structure comprises the control instructions, which upon execution causes the apparatus to perform any of the aspects of the disclosed embodiments as described above.

FIG. 10 illustrates a user interface (UI) 1001 in a portable apparatus having an input interface 1002, which as described in above embodiments can be actuated by a user for selection and navigation, and a display interface 1004 for displaying information, such as lists of items and playlists, to the user as described in the above embodiments.

The disclosed embodiments have mainly been described above with reference to a few embodiments. However, as is readily appreciated by a person skilled in the art, other embodiments than the ones disclosed above are equally possible within the scope of the disclosed embodiments, as defined by the appended patent claims. Any combination of the elements from any of the appended claims are to be considered possible, unless otherwise explicitly stated.

What is claimed is:

1-28. (canceled)

29. A method for a portable apparatus, comprising:
enabling selection of a first item in a display view from a multitude of lists of items; and
upon selection of first item, associating a selected first item with a playlist comprising at least the selected item, wherein said item or items in said playlist are arranged in sequential order.

30. The method according to claim 29, further comprising enabling selection of a further item or items from said multitude of lists and associating said further selected item or items with said playlist.

31. The method according to claim 29, further comprising re-arranging selected associated items in said playlist in a second sequential order.

32. The method according to claim 29, further comprising rendering an associated item in said playlist.

33. The method according to claim 29, wherein any of said multitude of lists and said playlist is a list comprising multimedia items.

34. The method according to claim 29, wherein said items are any items of the group comprising:
an audio item, a video item, and a picture item.

35. An apparatus comprising a display and means for navigating among items displayed on said display, arranged to display a view comprising a first list of items on said display and being capable of enabling selection of a first item among said items by said means for navigation, wherein upon selection of said first item, being arranged to associate the said selected item with a playlist, and further being capable of enabling selection of a further item or items from a multitude of lists by said means for navigation, wherein upon selection of said further items, being arranged to associate the said selected items with said playlist, wherein said item or items in said playlist are arranged in a sequential order.

36. The apparatus according to claim 35, further comprising a renderer, wherein items associated with said playlist are enabled to be rendered upon selection.

37. The apparatus according to claim 35, being arranged to render items associated with a playlist in said sequential order.

38. The apparatus according to claim 35, further comprising a renderer for enabling selection of a further item or items from said multitude of lists.

39. The apparatus according to claim 35, further comprising a renderer for re-arranging selected associated items in said playlist in a second sequential order.

40. The apparatus according to claim 35, further comprising a renderer for rendering said playlist comprising multimedia items.

41. The apparatus according to claim 35, further comprising a renderer for rendering items of the group comprising:
an audio item, a video item, and a picture item.

42. A computer-readable medium having computer-executable components comprising instructions for enabling selection of a first item in a display view from a multitude of lists of items; and upon selection of first item, association of a selected first item with a playlist comprising at least the selected item, wherein said item or items in said playlist are arranged in sequential order.

43. The computer-readable medium according to claim 42, further comprising instructions for enabling selection of a further item or items from said multitude of lists and associating said further selected item or items with said playlist.

44. The computer-readable medium according to claim 42, further comprising instructions for re-arranging selected associated items in said playlist in a second sequential order.

45. The computer-readable medium according to claim 42, further comprising instructions for rendering an associated item in said playlist.
